(19) United States
(12) Patent Application Publication
(10) Pub. No.: US 2014/0210685 A1
(43) Pub. Date: Jul. 31, 2014

(54) ELECTRONIC DEVICE AND ANTENNA CONTROL METHOD THEREOF

(71) Applicant: Acer Incorporated, New Taipei City (TW)

(72) Inventors: Chih-Hua Chang, New Taipei City (TW); Pei-Ji Ma, New Taipei City (TW); Kuo-Hua Tseng, New Taipei City (TW); Shao-Yu Huang, New Taipei City (TW)

(21) Appl. No.: 13/913,522

(22) Filed: Jun. 10, 2013

(30) Foreign Application Priority Data
Jan. 30, 2013 (TW) 102103552

(51) Int. Cl. H01Q 1/50; H01Q 1/38; H01Q 21/00

(52) U.S. Cl. CPC H01Q 1/50; H01Q 21/00; H01Q 1/38; H01Q 21/0087
USPC 343/861; 343/893; 343/700 MS; 29/601

(57) ABSTRACT

An electronic device including a first body and a second body is disclosed. The first body includes a first system circuit board, a first grounding element, and a primary antenna. The first grounding element is disposed on the first system circuit board. The primary antenna is disposed on the first system circuit board and electrically connected to the first grounding element. The primary antenna transmits/receives at least one radio frequency (RF) signal. The second body includes a second system circuit board and a clearance area. The clearance area is on the second system circuit board, and no circuit exists in the clearance area. When the first body and the second body are stacked by parallelizing the first system circuit board and the second system circuit board, the clearance area is corresponding to the primary antenna.

### CROSS-REFERENCE TO RELATED APPLICATION

This application claims the priority benefit of Taiwan application serial no. 102103552, filed on Jan. 30, 2013. The entirety of the above-mentioned patent application is hereby incorporated by reference herein and made a part of this specification.

### BACKGROUND OF THE INVENTION

1. Field of the Invention

The present invention generally relates to an electronic device, and more particularly, to an electronic device and an antenna control method thereof.

2. Description of Related Art

Along with the development of wireless communication technology, handheld electronic devices, such as smart phones, tablet computers, and notebook computers, have become the most indispensable tools in our daily life. Meanwhile, the functionality of handheld electronic devices has been extended immensely. Particularly, smart phones and tablet computers have gained the most growths among all handheld electronic devices. In a word, our life has been changed along with the advancement of wireless communication technology.

In order to gain market share in the ever-changing world of new technologies, manufacturers of handheld electronic devices have been investing a lot of resources into the development of more advanced software and hardware techniques. Take recently developed smart phones as example, even though the screens of existing smart phones have been enlarged to about 5″, the screen size cannot be further increased in consideration of the users' experience and convenience while using the smart phones. Thereby, some manufacturers are considering bringing the technique of convertible device into the mobile communication technology in expectation of providing a large screen display range with a limited device size.

A convertible device looks like a flip phone. However, unlike a flip phone, a convertible device can have two side-by-side screens or a single flexible screen. Since flexible display cannot be mass produced yet, most existing convertible devices in the market come with two screens.

A convertible device with two screens has two independent parts (i.e., two independent screens), and each part has its own components, such as a CPU, a screen, and a battery. These two parts can work independently, or, if the two parts are integrated, one of the two parts obtains the right of control and operates. Thus, the convertible device offers more flexibility in its operation compared to one closing device. However, the antenna design of the convertible device is more complicated than that of an existing smart phone.

Taking the antenna design of a typical flip phone as an example, when the flip phone is folded and in a close state, because the top panel of the phone is close to the antenna, the performance of the antenna is affected. Since in the close state, the antenna of the flip phone should only have a radiation capability for simply maintaining a connection between the flip phone and a base station, a low antenna performance is tolerable. However, when the top and bottom panels of a convertible device are completely stacked together, a user can still operate the device to connect to the Internet or make phone calls. Thus, how to make the primary antenna to achieve a radiation capability sufficient for satisfying the basic communication requirements of a cell phone in the stack mode is a major subject in the design of a convertible device.

On the other hand, a convertible device has different operation modes, such as a completely stacked mode, a partially stacked mode, and a screen extending mode in which the sides of the screens are joined to extend the screen. The performance of the antenna is affected by the screens, the active components and circuits that jointly disposed. Thus, how to make the antennas of the two independent parts of a convertible device to work properly in different operation modes is a also major subject in the design of the convertible device.

### SUMMARY OF THE INVENTION

Accordingly, the present invention is directed to an electronic device and an antenna control method thereof, in which an antenna of the electronic device is ensured to have a good radiation capability in different operation modes.

The present invention provides an electronic device including a first body and a second body. The first body includes a first system circuit board, a first grounding element, and a primary antenna. The first grounding element is disposed on the first system circuit board. The primary antenna is disposed on the first system circuit board and electrically connected to the first grounding element. The primary antenna transmits/receives at least one radio frequency (RF) signal. The second body includes a second system circuit board and a clearance area. The clearance area is on the second system circuit board, and no circuit exists in the clearance area. When the first body and the second body are stacked by parallelizing the first system circuit board and the second system circuit board, the clearance area is corresponding to the primary antenna.

The present invention provides an antenna control method adapted to an electronic device. The electronic device includes a first body and a second body. The antenna control method includes following steps. A first grounding element and a primary antenna are disposed on a first system circuit board of the first body, where the primary antenna transmits/receives at least one RF signal. A clearance area is configured on a second system circuit board of the second body, where no circuit exists in the clearance area. When the first body and the second body are stacked by parallelizing the first system circuit board and the second system circuit board, the clearance area is corresponding to the primary antenna.

As described above, the present invention provides an electronic device and an antenna control method thereof, in which a primary antenna is corresponding to a clearance area therefore is not affected by any other circuit or active components in the electronic device and accordingly achieves a good radiation capability.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a structure diagram of an electronic device according to an embodiment of the present invention.

FIG. 2 is a side view of an electronic device according to an embodiment of the present invention.

FIG. 3 is a flowchart of an antenna control method according to an embodiment of the present invention.

FIG. 4A-FIG. 4D are diagrams illustrating operation modes of an electronic device according to an embodiment of the present invention.

FIG. 5 is a structure diagram of an electronic device according to an embodiment of the present invention.

FIG. 6 is a functional block diagram of a first body in an electronic device according to an embodiment of the present invention.

FIG. 7 is a functional block diagram of an antenna impedance matching unit according to an embodiment of the present invention.

FIG. 8 is a flowchart of an antenna control method according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

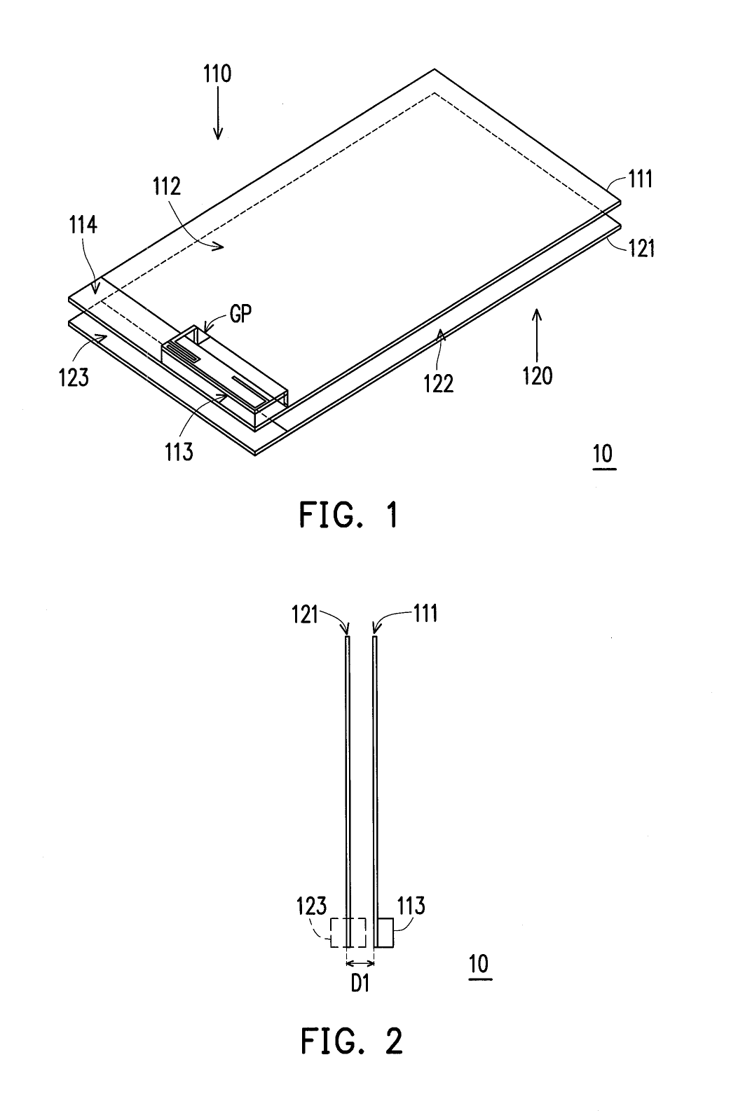

FIG. 1 is a structure diagram of an electronic device according to an embodiment of the present invention. Referring to FIG. 1, the electronic device 10 includes a first body 110 and a second body 120. The first body 110 includes a first system circuit board 111, a first grounding element 112, and a primary antenna 113. The first grounding element 112 is disposed on the first system circuit board 111. The primary antenna 113 is disposed on the first system circuit board 111 and electrically connected to the first grounding element 112 through a grounding point GP. The primary antenna 113 transmits/receives at least one radio frequency (RF) signal. The second body 120 includes a second system circuit board 121 and a clearance area 123. The clearance area 123 is on the second system circuit board 121, and no circuit exists in the clearance area 123 (for example, no grounding element exists in the clearance area 123). When the first body 110 and the second body 120 are stacked by parallelizing the first system circuit board 111 and the second system circuit board 121, the clearance area 123 is corresponding to the primary antenna 113.

In other words, when the first body 110 and the second body 120 are stacked, the projection area of the primary antenna 113 on the second system circuit board 121 has to be the clearance area. Meanwhile, in order to minimize the impact of the environment to the radiation capability of the primary antenna 113, in the present embodiment, a non-grounding area 114 close to the primary antenna 113 is further configured on the first system circuit board 111.

In the present invention, the electronic device 10 is a convertible device, and besides the components mentioned above, the first body 110 further includes some other major components, such as a processing unit, a display unit, a power supply unit, and an input/output unit, such that the first body 110 can work independently from the second body 120.

On the other hand, in an embodiment of the present invention, the second body 120 further includes major components such as a processing unit, a display unit, a power supply unit, and an input/output unit and can work independently when the second body 120 and the first body 110 are separated. In the present embodiment, the second body 120 further includes a secondary antenna (not shown) and a second grounding element 122 disposed on the second system circuit board 121. The secondary antenna is also electrically connected to the second grounding element 122 and transmits/receives at least one RF signal when the second body 120 work independently. It should be noted that the second grounding element 122 may bring a large impact on the radiation capability of an antenna (e.g., the primary antenna 113) therefore cannot be disposed in the clearance area 123.

It should be mentioned that besides the components mentioned above which have big impact on the radiation capability of an antenna (for example, the second grounding element 122 or an active component with large data processing capacity), components having little or no impact on the radiation capability of the primary antenna 113, such as a microphone, a speaker, a magnet, or a connection port with low data transmission capacity, can still be disposed in the clearance area 123 and the non-grounding area 114.

On the other hand, in the embodiment illustrated in FIG. 1, the first body 110 and the second body 120 are of the same size. However, in other embodiments, the sizes of the first body 110 and the second body 120 may be different. The operation capabilities of the processing units and/or the signal transmitting/receiving capabilities of the primary antenna 113 and the secondary antenna in the first body 110 and the second body 120 may be different. For example, the processing unit in the first body 110 has a good operation capability and offers a phone call function, while the processing unit in the second body 120 has a relatively low operation capability but offers a large screen size. However, the embodiments mentioned above are not intended to limit the scope of the present invention.

In an embodiment of the present invention, when the first body 110 and the second body 120 are electrically connected with each other, the electronic device 10 disables the transmitting/receiving function of the secondary antenna and uses only the primary antenna 113 for transmitting/receiving the at least one RF signal. Thus, the secondary antenna can be disposed at anywhere outside the clearance area 123 on the second system circuit board 121. It should be mentioned that when the first body 110 and the second body 120 are electrically connected with each other, the first grounding element 112 and the second grounding element 122 can be electrically connected according to the actual implementation requirement.

FIG. 2 is a side view of an electronic device according to an embodiment of the present invention. Referring to FIG. 2, the first system circuit board 111 and the second system circuit board 121 can be really close (for example, the distance D1 can be less then 10 mm) even with the consideration of disposing the internal/external components, the supporting structure and the casing of the electronic device 10. Thus, if the clearance area 123 is not configured, when the first body 110 and the second body 120 are stacked, the second grounding element 122 disposed on the second body 120 and the active components and circuits on the second system circuit board 121 will affect the radiation capability of the primary antenna 113.

Additionally, in both FIG. 1 and FIG. 2, the first body 110 is stacked on the second body 120. The dispositions of the primary antenna 113 and the clearance area 123 described above are also applicable when the second body 120 is stacked on the first body 110. In FIG. 1 and FIG. 2, both the primary antenna 113 and the clearance area 123 are disposed on the bottom of the electronic device 10. However, the positions of the primary antenna 113 and the clearance area 123 on the first body 110 and the second body 120 are not limited in the present invention, and it is within the scope of the present invention as long as the clearance area 123 is corresponding to the primary antenna 113 when the first body 110 and the second body 120 are stacked by parallelizing the first system circuit board 111 and the second system circuit board 121.

The implementations of the primary antenna 113 and the secondary antenna are not limited in the present invention and can be determined according to the actual requirement, such as the transmitted/received signals and the size of the disposition space. In an embodiment of the present invention, the primary antenna 113 is a loop antenna with a RF signal transmitting/receiving capability between 824-960 million hertz (MHz) and 1710-2170 MHz.

Thereby, in the present embodiment, the primary antenna 113 is configured to transmit/receive 850/900/180/1900 MHz RF signals of global system for mobile communications (GSM) and RF signals of five different frequencies in band I of wideband code division multiple access (WCDMA) RF signals in a wireless wide area network (WWAN). The secondary antenna is configured to transmit/receive RF signals in the same band as those transmitted/received by the primary antenna 113 or RF signals in different bands. However, the present invention is not limited to aforementioned implementation and the antennas can be configured according to the actual requirement.

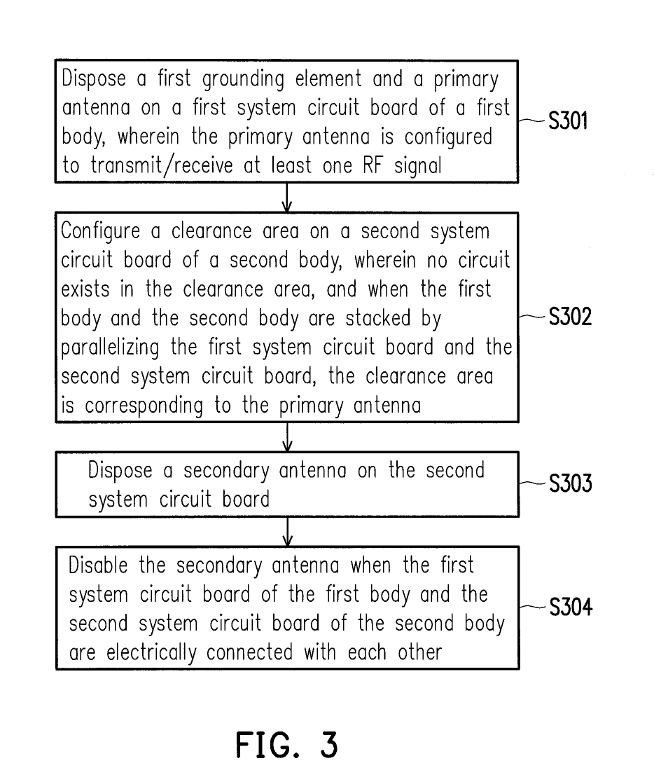

The present invention also provides an antenna control method suitable for the electronic device 10 described in the embodiment illustrated in FIG. 1. FIG. 3 is a flowchart of an antenna control method according to an embodiment of the present invention. Referring to FIG. 3, in the first step S301, a first grounding element and a primary antenna are disposed on a first system circuit board of a first body. The primary antenna is configured to transmit/receive at least one RF signal. Then, in step S302, a clearance area is configured on a second system circuit board of a second body, where no circuit exists in the clearance area. When the first body and the second body are stacked by parallelizing the first system circuit board and the second system circuit board, the clearance area is corresponding to the primary antenna.

Referring to FIG. 3 again, in an embodiment of the present invention, the antenna control method further includes following steps after step S302. First, in step S303, a secondary antenna is disposed on the second system circuit board. In step S304, when the first system circuit board of the first body and the second system circuit board of the second body are electrically connected with each other, the secondary antenna is disabled. The detailed descriptions of these steps can be referred to the embodiments illustrated in FIG. 1 and FIG. 2.

Moreover, the way in which the first body 110 and the second body 120 of the electronic device 10 are stacked together is not limited to that in the embodiment illustrated in FIG. 1. Meanwhile, when the screens of the first body 110 and the second body 120 are touch screens, the stacked patterns of the first body 110 and the second body 120 are directly corresponding to different operation modes of the electronic device 10. In the embodiment illustrated in FIG. 1, the first body 110 and the second body 120 overlap each other, which is considered the first operation mode of the electronic device 10. In the first operation mode, only the screen of the first body 110 is exposed, or the screens of both the first body 110 and the second body are exposed and opposite to each other. In this operation mode, a user is usually allowed to make phone calls.

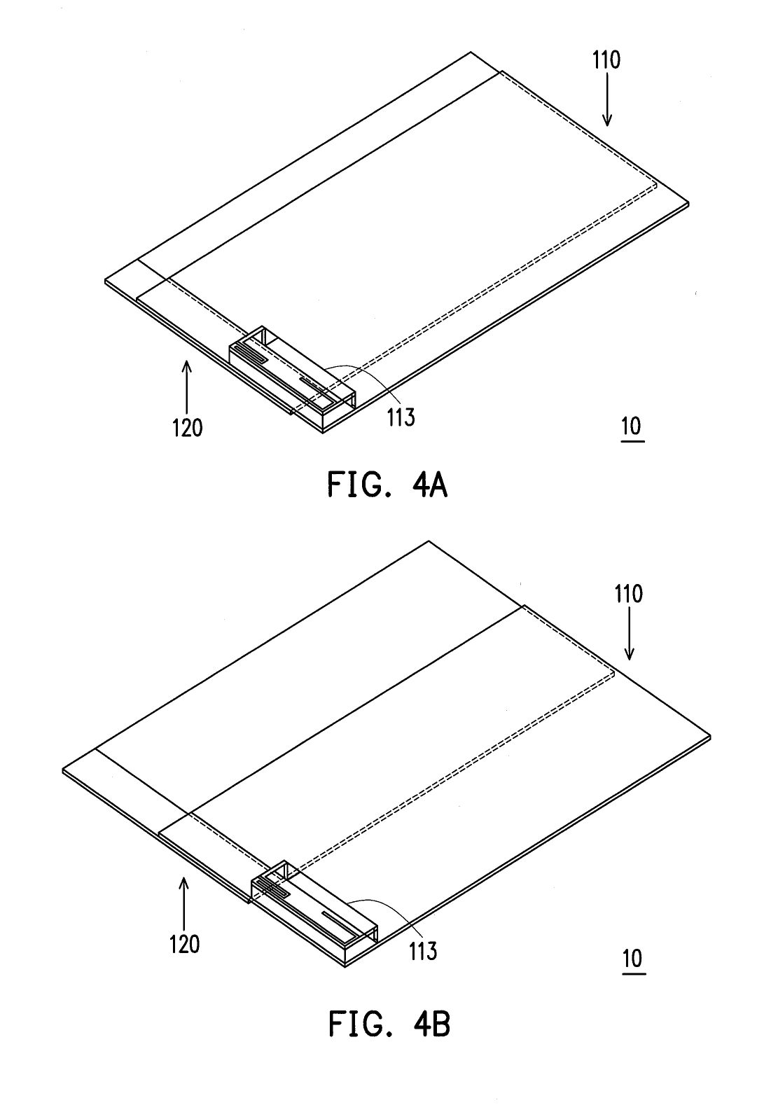

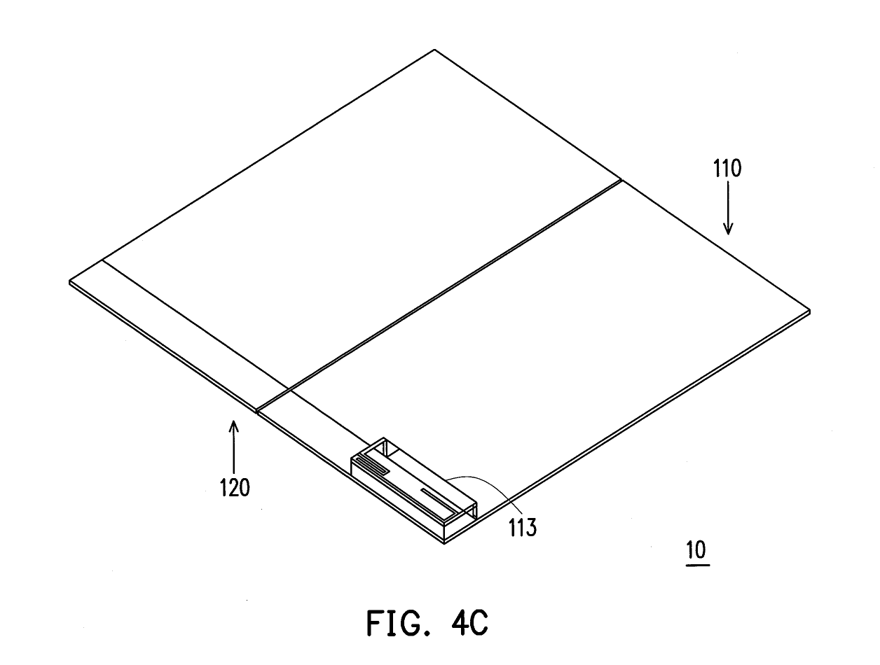

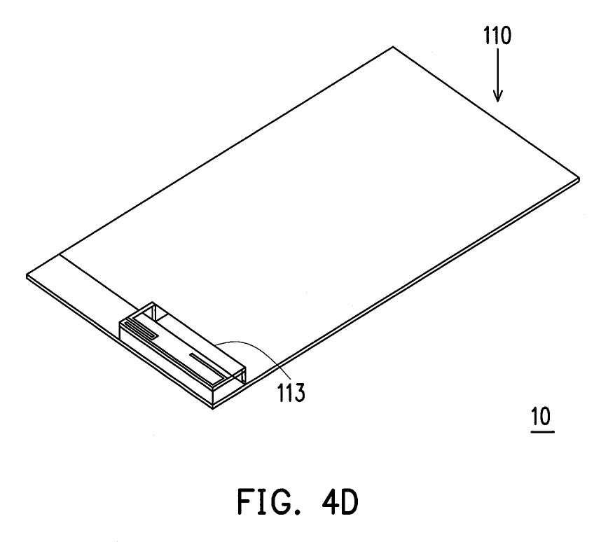

FIG. 4A-FIG. 4D are diagrams illustrating operation modes of an electronic device according to an embodiment of the present invention. FIG. 4A illustrates the electronic device 10 in the second operation mode. In the second operation mode, the first body 110 and the second body 120 partially overlap each other. The screen of the first body 110 may be used for display purpose, while a plurality of virtual keys may be configured on the exposed part of the second body 120 for receiving user operations. FIG. 4B illustrates the electronic device 10 in the third operation mode. In the third operation mode, similar to that in the second operation mode illustrated in FIG. 4A, the first body 110 and the second body 120 partially overlap each other. However, compared to that in FIG. 4A, the overlapped area between the first body 110 and the second body 120 in FIG. 4B is smaller. When the screen of the first body 110 is used for display purpose, a complete virtual keyboard can be shown on the screen of the second body 120 in order to allow a user to input data.

FIG. 4C illustrates the electronic device 10 in the fourth operation mode. In the fourth operation mode, the first body 110 and the second body 120 are joined to each other side by side, and the electronic device 10 displays data on the combined screen of the first body 110 and the second body 120. FIG. 4D illustrates the electronic device 10 in the fifth operation mode. In the fifth operation mode, the first body 110 and the second body 120 work independently, and accordingly the second body 120 is not illustrated in FIG. 4D. In the fifth operation mode, the user can use either the first body 110 or the second body 120 independently (for example, make a phone call by holding the first body 110 close to the user's ear and at the same time watch a video by holding the second body 120 in front of the user's eyes). It should be noted that the operation modes in foregoing FIG. 1 and FIGS. 4A-4D and the user operations respectively corresponding to these operation modes are only examples but not intended to limit the scope of the present invention.

It should be mentioned that in the present invention, regardless of which operation mode (for example, the first operation mode, the second operation mode, or the third operation mode) the electronic device 10 is in, the projection area of the primary antenna 113 on the second body 120 has to be the clearance area (for example, the clearance area 123 illustrated in FIG. 1) in order to ensure a good radiation capability of the primary antenna 113.

Additionally, in each of aforementioned operation modes, the first body 110 and the second body 120 have different relation, and the impact of the second body 120 on the radiation capability of the primary antenna 113 is also different. Thus, in the present invention, the radiation capability of the primary antenna 113 is adjusted regarding such variations in order to maintain the optimal signal transmitting/receiving capability of the primary antenna 113.

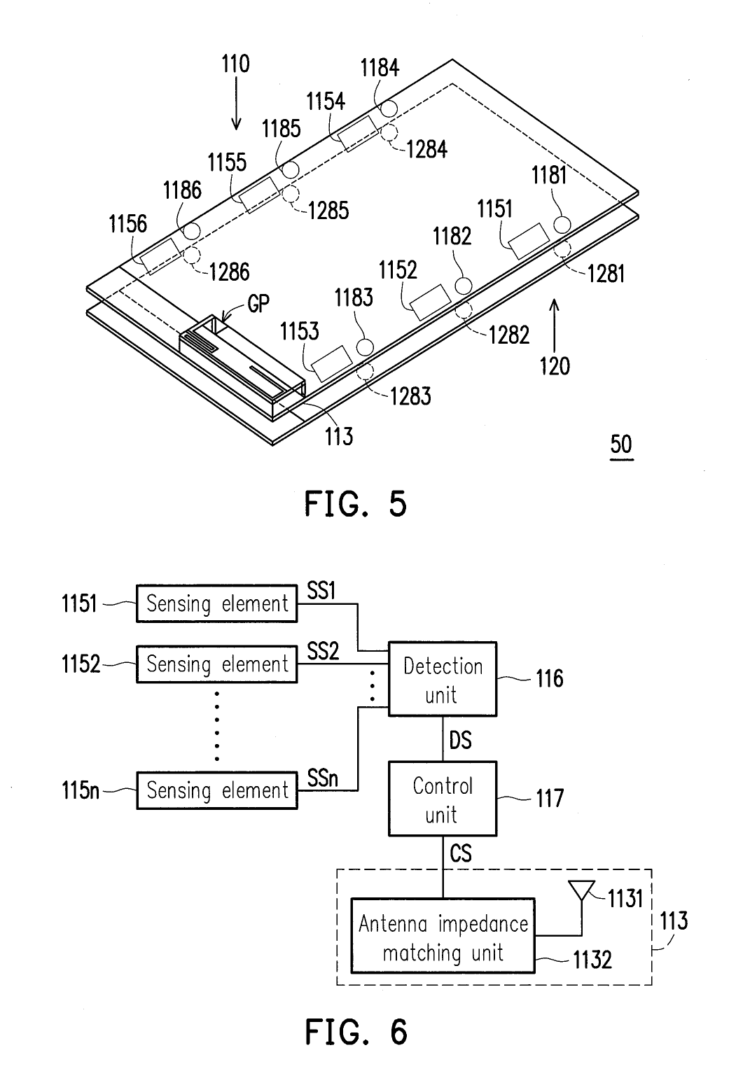

FIG. 5 is a structure diagram of an electronic device according to an embodiment of the present invention. Referring to FIG. 5, unlike that in the embodiment illustrated in FIG. 1, the first body 110 in the electronic device 50 further includes magnets 1181-1186 and sensing elements 1151-1156, and the second body 120 further includes magnets 1281-1286 which are disposed respectively corresponding to the magnets 1181-1186 of the first body 110. In the present embodiment, the magnets 1181-1186 and 1281-1286 help the user to fix the first body 110 and the second body 120 in different operation modes.

In the present embodiment, the sensing elements 1151-1156 are magnetic sensors. The sensing elements 1151-1156 are respectively disposed beside the magnets 1181-1186 and generate sensing signals according to sensed magnetic forces. The electronic device 50 further determines the current operation mode according to the sensing signals and adjusts the impedance matching value of the primary antenna 113 according to the current operation mode, so as to maintain the radiation capability of the primary antenna 113. Below, this operation will be explained in detail with reference to accompanying drawings.

FIG. 6 is a functional block diagram of a first body in an electronic device according to an embodiment of the present invention. Referring to FIG. 5 and FIG. 6, the first body 110 includes sensing elements 1151-115n, a detection unit 116, a control unit 117, and a primary antenna 113, wherein the first system circuit board 111 and the first grounding element 112 are omitted in FIG. 6. The sensing elements 1151-115n, corresponding to the sensing elements 1151-1156 in FIG. 5, generate sensing signals SS1-SSn according to sensed magnetic forces. The detection unit 116 is coupled to the sensing elements 1151-1156. The detection unit 116 receives the sensing signals SS1-SSn and generates a detection signal DS according to the sensing signals SS1-SSn when part or all of the sensing signals SS1-SSn change. The control unit 117 is coupled to the detection unit 116 and the primary antenna 113. The control unit 117 determines the current operation mode according to the detection signal DS and generates a control signal CS according to the operation mode. The primary antenna 113 adjusts the impedance matching value of the primary antenna according to the control signal CS.

For example, the user switches the electronic device 50 from the first operation mode (as shown in FIG. 1) to the fourth operation mode (as shown in FIG. 4C) to change the relative position of the first body 110 and the second body 120. Thus, the magnetic forces sensed by the sensing elements 1151-115n (the sensing elements 1151-1156) change, and accordingly the sensing signals SS1-SSn generated by the sensing elements 1151-115n also change. Because the electronic device 50 is switched from the first operation mode to the fourth operation mode, the magnetic forces sensed by the sensing elements at one side of the electronic device 50 (for example, the sensing elements 1151-1153) change slightly, while the magnetic forces sensed by the sensing elements at the other side of the electronic device 50 (for example, the sensing elements 1154-1156) change considerably.

The detection unit 116 receives the sensing signals SS1-SSn, and when The detection unit 116 detects that part or all of the sensing signals SS1-SSn change, the detection unit 116 generates the detection signal DS according to the sensing signals SS1-SSn with various changes. The control unit 117 determines that the current operation mode is the fourth operation mode according to the detection signal DS. The control unit 117 further generates the control signal CS according to the fourth operation mode and transmits the control signal CS to the primary antenna 113, so that the primary antenna 113 can adjust the impedance matching value in accordance with the fourth operation mode.

In the present embodiment, the control unit 117 pre-configures a plurality of operation modes (for example, the first to the fifth operation mode shown in FIG. 1 and FIGS. 4A-4D) in a table. The control unit 117 determines the current operation mode of the electronic device 50 according to the detection signal DS and aforementioned table through table lookup.

The primary antenna 113 includes an antenna body 1131 and an antenna impedance matching unit 1132. The antenna impedance matching unit 1132 is coupled to the control unit 117 and the antenna body 1131 and adjusts the impedance matching value of the primary antenna 113 according to the control signal CS. Below, the implementation of the antenna impedance matching unit 1132 will be explained with reference to an embodiment and accompanying drawings.

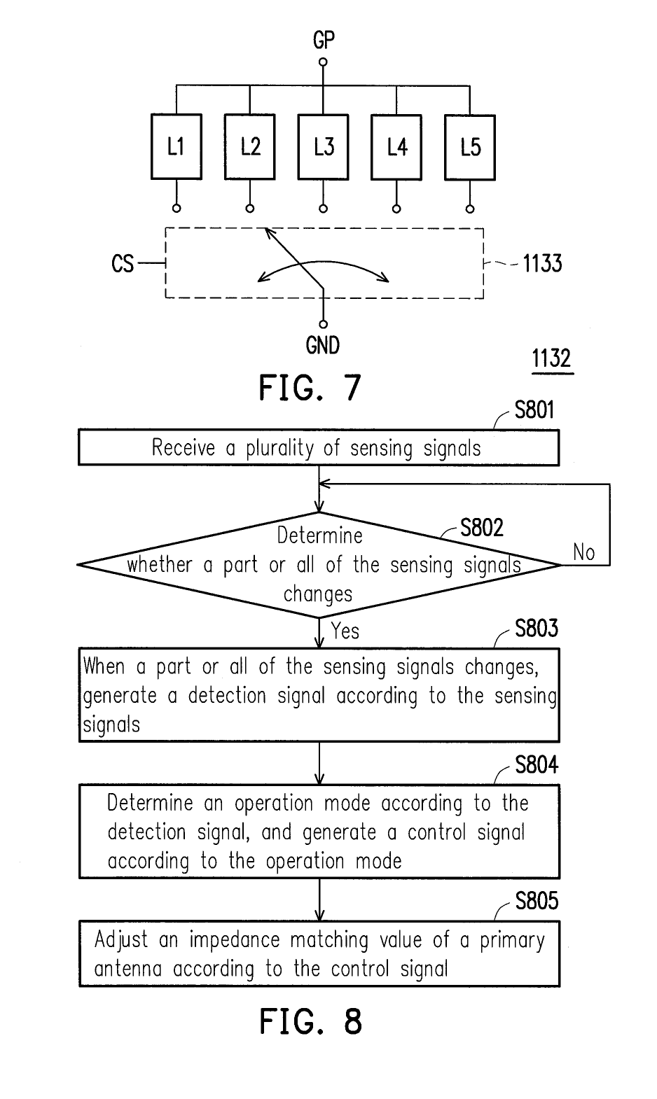

FIG. 7 is a functional block diagram of an antenna impedance matching unit according to an embodiment of the present invention. Referring to FIG. 5 and FIG. 7, the antenna impedance matching unit 1132 includes impedance units L1-L5 and a switch 1133. The impedance units L1-L5 are coupled between the grounding point GP of the antenna body 1131 and a node GND. The node GND is coupled to the first grounding element 112 on the first body 110. The switch 1133 is coupled between the impedance units L1-L5 and the node GND. The switch 1133 switches to conduct a path between one of the impedance units L1-L5 and the node GND (the first grounding element 112) according to the control signal CS.

In the present embodiment, the impedance units L1-L5 are respectively corresponding to the first to the fifth operation mode illustrated in FIG. 1 and FIGS. 4A-4D and respectively have the optimal inductance corresponding to each operation mode. The switch 1133 conducts the path between the impedance unit corresponding to the current operation mode (one of the impedance units L1-L5) and the node GND according to the control signal CS. For example, in the embodiment described above, when the electronic device 50 is switched from the first operation mode to the fourth operation mode, the switch 1133 changes from conducting the path between the impedance unit L1 and the node GND to conducting the path between the impedance unit L4 and the node GND according to the control signal CS.

It should be mentioned that the control unit 117 determining the current operation mode of the electronic device 50 through table lookup along with the implementation of the antenna impedance matching unit 1132 illustrated in FIG. 7 is only an example but not intended to limit the scope of the present invention. Any component that determines the current operation mode according to signals sensed by sensing elements and adjusts the impedance matching value of an antenna according to the operation mode falls within the scope of the present invention.

FIG. 8 is a flowchart of an antenna control method according to an embodiment of the present invention. The steps illustrated in FIG. 8 are operations may be performed after the step S302 or S304 in FIG. 3. Referring to FIG. 8, first, a plurality of sensing signals is received (step S801). Then, whether a part or all of the sensing signals changes is determined (step S802). When a part or all of the sensing signals changes, a detection signal is generated according to the sensing signals (step S803). Next, the operation mode is determined according to the detection signal, and a control signal is generated according to the operation mode (step S804), Thereafter, the impedance matching value of the primary antenna is adjusted according to the control signal (step S805). The detailed implementations of the steps S801-S805 of the antenna control method can be referred to descriptions of the embodiments illustrated in FIG. 1 to FIG. 7 and will not be described herein.

As described above, the present invention provides an electronic device and an antenna control method thereof, in which when a first body and a second body of the electronic device are stacked, a primary antenna on the first body is not affected by any grounding element or active component on the second body, so that a good RF signal transmitting/receiving capability of the primary antenna can be maintained. Additionally, in the present invention, an impedance matching value of the primary antenna can be dynamically adjusted according to how the first body and the second body of the electronic device are stacked and arranged, so that the electronic device can offer a good RF signal transmitting/receiving capability in any operation mode.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An electronic device, comprising:
a first body, comprising:
a first system circuit board;
a first grounding element, disposed on the first system circuit board;
a primary antenna, disposed on the first system circuit board, electrically connected to the first grounding element, and transmitting/receiving at least one radio frequency (RF) signal; and
a second body, comprising:
a second system circuit board; and
a clearance area, located on the second system circuit board, wherein no circuit exists in the clearance area,
wherein when the first body and the second body are stacked by parallelizing the first system circuit board and the second system circuit board, the clearance area is corresponding to the primary antenna.

2. The electronic device according to claim 1, wherein the second body comprises:
a second grounding element, disposed on the second system circuit board; and
a secondary antenna, disposed on the second system circuit board, and transmitting/receiving the at least one RF signal,
wherein both the second grounding element and the secondary antenna are disposed outside the clearance area; and
when the first system circuit board of the first body and the second system circuit board of the second body are electrically connected with each other, the secondary antenna is disabled.

3. The electronic device according to claim 1, wherein the first body comprises:
a plurality of sensing elements, generating a plurality of sensing signals;
a detection unit, coupled to the sensing elements, receiving the sensing signals, and generating a detection signal according to the sensing signals when a part or all of the sensing signals changes; and
a control unit, coupled to the detection unit and the primary antenna, determining an operation mode according to the detection signal, and generating a control signal according to the operation mode,
wherein the primary antenna adjusts an impedance matching value of the primary antenna according to the control signal.

4. The electronic device according to claim 3, wherein the primary antenna comprises:
an antenna body, comprising a grounding point; and
an antenna impedance matching unit, coupled to the control unit and the antenna body, and adjusting the impedance matching value according to the control signal.

5. The electronic device according to claim 4, wherein the antenna impedance matching unit comprises:
a plurality of impedance units, coupled to the grounding point of the antenna body; and
a switch, coupled between the grounding point and the first grounding element, and switching to conduct a path between one of the impedance units and the first grounding element according to the control signal.

6. The electronic device according to claim 3, wherein
the sensing elements are respectively a magnetic sensor; and
the second body further comprises a plurality of magnets, and the magnets are disposed corresponding to the sensing elements,
wherein the sensing elements generate the sensing signals according to sensed magnetic forces.

7. The electronic device according to claim 3, wherein
the control unit generates the control signal according to the operation mode through table lookup.

8. An antenna control method, adapted to an electronic device, wherein the electronic device comprises a first body and a second body, the antenna control method comprising:
disposing a first grounding element and a primary antenna on a first system circuit board of the first body, wherein the primary antenna transmits/receives at least one radio frequency (RF) signal; and
configuring a clearance area on a second system circuit board of the second body, wherein no circuit exists in the clearance area,
wherein when the first body and the second body are stacked by parallelizing the first system circuit board and the second system circuit board, the clearance area is corresponding to the primary antenna.

9. The antenna control method according to claim 8 further comprising:
disposing a second grounding element on the second system circuit board of the second body; and
disposing a secondary antenna on the second system circuit board,
wherein when the first system circuit board of the first body and the second system circuit board of the second body are electrically connected with each other, disabling the secondary antenna.

10. The antenna control method according to claim 8 further comprising:
receiving a plurality of sensing signals;
when a part or all of the sensing signals changes, generating a detection signal according to the sensing signals;
determining an operation mode according to the detection signal, and generating a control signal according to the operation mode; and
adjusting an impedance matching value of the primary antenna according to the control signal.

11. The antenna control method according to claim 10, wherein the electronic device further comprises a plurality of impedance units, and the step of adjusting the impedance matching value of the primary antenna according to the control signal further comprises:
switching to conduct a path between one of the impedance units and the first grounding element.

12. The antenna control method according to claim 10, wherein the step of generating the sensing signals comprises:
respectively generating the sensing signals according to sensed magnetic forces.
